(19) United States
(12) Patent Application Publication
(10) Pub. No.: US 2011/0214384 A1
(43) Pub. Date: Sep. 8, 2011

(54) Flashing for Integrating Windows with Weather Resistant Barrier

(75) Inventors: Barbara Klimowicz O'Rourke, Newark, DE (US); Barbara Jean Crowder-Moore, Church Road, VA (US); James Dean Katsaros, Midlothian, VA (US); Ashok Harakhlal Shah, Midlothian, VA (US)

(73) Assignee: E. I. DU PONT DE NEMOURS AND COMPANY, Wilmington, DE (US)

(21) Appl. No.: 12/879,379

(22) Filed: Sep. 10, 2010

Related U.S. Application Data
(62) Division of application No. 11/640,666, filed on Dec. 18, 2006.

(51) Int. Cl. E04B 1/64; E04B 1/68; B32B 3/00; B32B 38/00

(52) U.S. Cl. 52/741.4; 428/189; 428/190; 156/227

(57) ABSTRACT

A self-adhesive flashing for integrating a flanged fenestration unit installed in a rough opening in a wall with a water resistive barrier where the flashing includes an elongated substrate having a pressure-sensitive adhesive layer adhered to at least one side of the substrate along a lateral edge of the substrate and methods for applying the flashing.

### BACKGROUND OF THE INVENTION

1. Field of the Invention

The present invention relates to flashing for preventing the ingress of moisture into a wall of a building around an installed window.

2. Description of the Related Art

In “open-stud” building construction, windows and other fenestration products are installed directly into building openings formed by framing members (e.g., wood studs) prior to the installation of water resistive barrier (“WRB”) over the framing members which form the wall cavities. Two types of flashing are known for use in open-stud construction. One type of flashing is “nail-on flashing” formed from a strip of water-impermeable film which is nailed to the wood studs before a window is installed such that, upon window installation, the edge of the flashing is covered by the window flange. A second type of flashing is “self-adhered flashing” formed from a water-impermeable film with a strip of adhesive along the edge for attachment to the window flange along the vertical jambs and the horizontal head of the window, wherein the adhesive is covered by a release liner. Self-adhered flashing can also comprise adhesive over an entire surface. Water resistive barrier is subsequently installed over the framed walls of the building such that around the window, the water resistive barrier covers the flashing at the vertical jambs and head of the window and is layered behind the flashing at the window sill.

According to conventional practice in open-stud construction, the space between the water resistive barrier and the flashing at the vertical jambs and head is not sealed, thus creating the possibility of rainwater entering between the WRB and the flashing. The purpose of the flashing is to divert such water down and eventually to the outside of the WRB at the sill. Under excessive wind forces, water that has entered the space behind the WRB can travel beyond the width of the flashing into the wall cavity which may result in moisture damage to the framing members, such as rotting of wood studs and loss of insulation.

It would be desirable to have a cost-effective means for reducing the likelihood of water penetration into wall cavities around flanged fenestration units in open-stud building construction. In particular, it would be desirable to have a flashing product that utilizes pressure-sensitive adhesive to integrate the window flange with the water resistive barrier which minimizes the amount of adhesive used.

### SUMMARY OF THE INVENTION

In at least one embodiment of the invention there is a flashing for integrating a flanged fenestration unit and a water resistive barrier, the flashing comprising

an elongated flexible substrate having two major surfaces and a first lateral edge and second lateral edge defining a width of the substrate therebetween;

an elongated adhesive layer having a width less than the width of the substrate adhered to one of the major surfaces of the substrate adjacent the first lateral edge of the substrate; and

a release liner covering the adhesive layer wherein the release liner is scored or perforated along a line parallel to the first lateral edge of the substrate and located a distance from the first lateral edge that is less than the width of the adhesive layer dividing the release liner into a first release liner section adjacent the first lateral edge and a second release liner section,

and methods for installing in a building.

### BRIEF DESCRIPTION OF THE DRAWINGS

FIG. 1 is a cross-sectional side view of the flashing according to one embodiment of the invention.

FIG. 2 is a cross-sectional side view of the flashing according to another embodiment of the invention.

FIG. 3 is a cross-sectional side view of the flashing material flashing according to yet another embodiment of the invention.

FIGS. 4A-4C depict methods for utilizing the flashing of the invention in an open-stud wall construction.

FIG. 5 is a cross-sectional side view of the flashing material flashing according to yet another embodiment of the invention.

FIG. 6 depicts a cross-sectional side view of the flashing material of FIG. 5 as attached to a window flange.

### DETAILED DESCRIPTION OF THE INVENTION

The invention relates to an improved flashing product for use along the vertical jambs, head, and sill of a flanged fenestration unit, such as a window, that integrates the peripheral flange of the fenestration unit with a water resistive barrier installed over the framing members of the building. The use of the improved flashing product prevents the ingress of moisture into the wall cavity surrounding the fenestration unit. It should be appreciated that when the term “window” is used, other types of fenestration units, such as doors, skylights, vents, utility supply boxes, and other items that are made to fit into openings in structures, such as buildings, are contemplated.

FIG. 1 illustrates a cross-sectional side view of the flashing 10 as one embodiment of the invention. It should be noted that the drawings presented herein are not to scale and are non-limiting.

The flashing 10 comprises a substrate 12 having an adhesive layer 14 partially covering one surface near a lateral edge 16 of the substrate. The adhesive layer is covered by release liner 18. Advantageously, the release liner 18 is scored or perforated (as indicated by the dotted line) along a line parallel to lateral edge 16 for ease of folding the release liner and adhesive layer along the line as well as for ease of separately removing release liner sections 18a and 18b to separately expose, respectively, underlying sections 14a and 14b of the adhesive layer. If desired, film 16 is also scored to aid in folding the film along the score line.

The adhesive layer 14 integrates the window flange and the WRB in use, as adhesive layer section 14a attaches directly to the WRB and adhesive layer section 14b attaches directly to the window flange. In order to install the flashing of the invention to a window installed in a building opening in open-stud construction, the lateral edge sections of the release liner and adhesive layer (18a and 14a, respectively) and the attached lateral edge portion of substrate 12 are folded back along the scored line in the release liner 18 such that the substrate 12 is folded onto itself. Release liner section 18b is removed from the flashing and the underlying section of adhesive 14b is exposed and adhered to the window flange. Subsequently, release liner section 18a is also removed, exposing the adhesive of the adhesive layer section 14a so that it is available to be adhered to the WRB when the WRB is installed. The integration of the window flange and the WRB prevents the ingress of water into the wall cavity behind the WRB around the window.

The substrate 12 of the flashing of the invention can be a film, sheet metal, nonwoven fabric, woven fabric, paper, rigid plastic, or a combination thereof. The substrate is liquid water impermeable and can be either water vapor permeable or water vapor impermeable. The substrate can be a material that has been made water impermeable by the use of a water impermeable coating. The substrate can be a nail-sealable film such as Titanium-UDL® roof underlayment commercially available from InterWrap, Inc. of Canada. The flashing can be at least 9 inches (22.9 cm) wide if required by applicable industry standards, e.g., ASTM E 2112; otherwise it can be less than 9 inches (22.9 cm) wide.

The substrate 12 should be dimensionally stable and durable under the conditions of temperature and humidity experienced by the flashing in use. The substrate should not shrink or curl which could result in delamination of the flashing or separation of the flashing from the framing member or window flange. Such separation could create channels through which water could migrate into the wall cavity surrounding the window flange. For ease of installation of the flashing of the invention, the substrate should have sufficient stiffness so it does not easily fold over on itself at the upper corners of the window. The substrate is advantageously tear resistant.

The substrate 12 should not react with the adhesive layer 14 in a manner detrimental to the structural integrity and dimensional stability of the substrate. In the case of a polymeric substrate, the substrate is made of a polymer having a sufficiently high softening temperature. Suitable polymers include polyethylene, polypropylene, polyethylene terephthalate, polyamide, or a blend or copolymer thereof. The substrate can include optional additives such as UV stabilizers, antioxidants, antimicrobial agents, pigments, etc. The substrate 12 can optionally be translucent if it is desirable for the framing elements 20 to be visible behind the installed flashing 10.

For enhanced adhesion with the adhesive layer 14, the substrate 12 can be subjected to a surface treatment, such as corona treatment or micro-embossing. The substrate can also be subjected to corona treatment for improved ink adhesion.

The adhesive used in adhesive layer 14 has good adhesion to the material of the substrate 12 as well as to a wide variety of construction materials, e.g., wood, aluminum, vinyl, and commonly used water resistive barriers such as DuPont® Tyvek® HomeWrap , available from E. I. du Pont de Nemours & Co., Wilmington, Del. (DuPont). The adhesive is stable under conditions of heat and moisture over an extended period of time. Suitable adhesives for use in the flashing of the invention include butyl rubber adhesive, bituminous adhesive, acrylic, or combinations thereof (layers and blends). Additionally, the adhesive can be neoprene, a polymer based on EPDM (ethylene propylene diene monomer), or other pressure sensitive adhesives generally used in construction applications.

The release liner 18 can optionally be provided with some level of water and UV resistance for protection in limited outdoor exposure during building construction. The outer surface of the release liner can be coated with a water resistant resin such as linear low density polyethylene, so that the adhesive bonds well to the outer surface of the release liner at locations where one piece of flashing crosses over another piece having the release liner covering the outer adhesive surface still in place during use, such as at the upper corners of a window. It is desirable for this release liner to be removed so that adhesive-to-adhesive contact occurs at these crossover locations. It is desirable for the release liner to be thin and flexible so that it will wind without excessive buckling when the flashing is wound onto a roll with the outer release liner on the inside of the roll. The flashing according to this embodiment of the invention is cost effective since an adhesive layer is needed only on one side of the flashing.

The invention also relates to a method for integrating WRB with the peripheral flange of a fenestration unit installed in a rough opening in a wall, in order to prevent the ingress of moisture into a wall cavity around the fenestration unit. A method for installing the above-described flashing of the invention is described as follows. A fenestration unit such as a window is first installed in a rough opening such that the peripheral flange overlaps the adjacent framing members. The flange is advantageously secured to the underlying framing members via screws, nails etc. As shown in FIG. 1, the portion of the flashing between edge 16 and the scored line is folded back so that substrate 12 is folded onto itself. Release liner section 18b is removed and adhesive layer section 14b of the flashing is adhered to the window flange. Release liner section 18a is removed and adhesive layer section 14a of the flashing is exposed. Finally, WRB is installed over the wall surrounding the window and adhered to exposed adhesive layer 14a of the flashing along the sides and uppermost portion of the window. At the lowermost portion of the fenestration unit, the WRB is advantageously covered by the substrate of the flashing so that the flashing covers the WRB in a shingling fashion and liquid water is directed to the exterior of the WRB and away from the wall cavity.

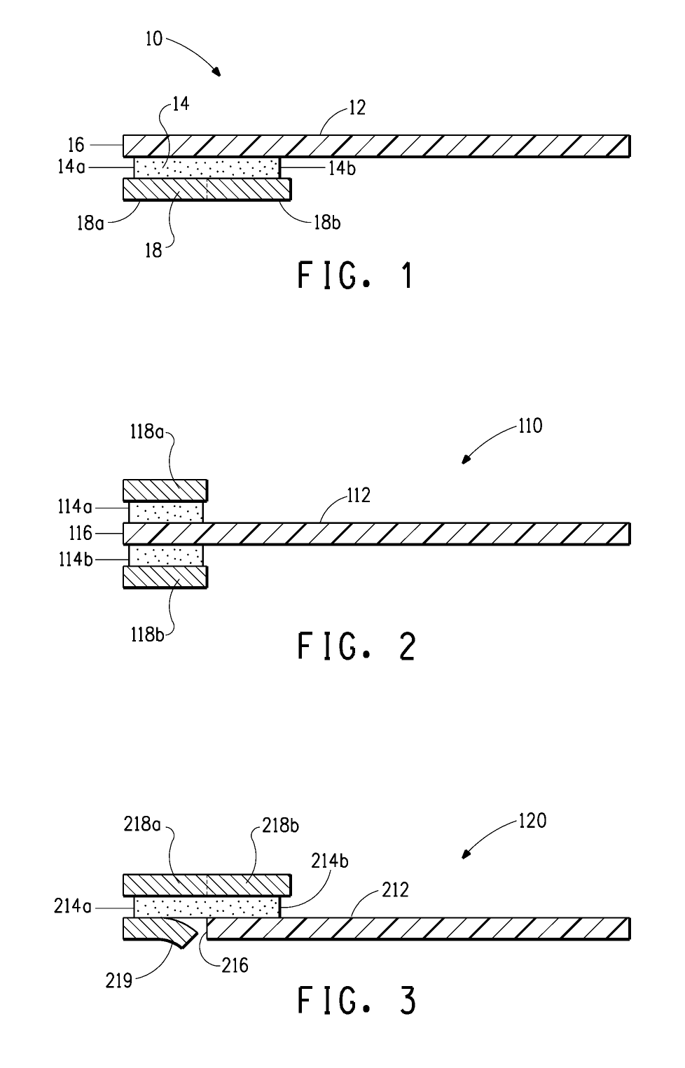

According to another embodiment of the invention, as illustrated in FIG. 2, the flashing 110 can have adhesive layers 114a and 114b adhered to each surface of the substrate 112 adjacent the lateral edge 116. The adhesive layer on each surface is covered by release liners 118a and 118b. The flashing 110 can be made by extruding the adhesive layers 114a and 114b directly onto each surface of the substrate.

Alternatively, another flashing embodiment 120 can be made as illustrated in FIG. 3. The flashing material 120 includes adhesive layer 214 adhered to one surface of substrate 212 such that a first portion of the adhesive layer 214b is adhered to the substrate adjacent lateral edge 216 and a second portion of the adhesive layer 214a extends significantly beyond lateral edge 216. Further, the second portion of the adhesive layer 214a can extend as much as about half of its width beyond lateral edge 216. Adhesive layer portions 114a and 114b can have different widths different than the width of 114b. The surface of the adhesive layer section 214b opposite the substrate is covered by release liner section 218b which is delineated by the scored line (as indicated by the dotted line) opposite the lateral edge 216. Optionally, an intermediate release liner 219 covers the other side of the portion of the adhesive layer 214a extending beyond edge 216 of the substrate. Intermediate release liner 219 is removed from the starting flashing material 120 prior to installation, and second portion of adhesive layer 214a is folded under lateral edge 216 to contact substrate 212, thus forming a flashing structure similar to flashing 110 illustrated in FIG. 2. Although intermediate release liner 219 has release coating functionality, the rest of the substrate 212 does not have release coating functionality, but rather remains adhered to the adhesive layer.

A method for installing the above-described embodiment of the flashing of the invention in order to integrate WRB with the peripheral flange of a fenestration unit installed in a rough opening in a wall to prevent the ingress of moisture into the wall around the fenestration unit, is described as follows. A fenestration unit such as a window is first installed in a rough opening such that the peripheral flange overlaps the adjacent framing members. The flange is advantageously secured to the underlying framing members via screws, nails etc. A portion of the release liner is removed to expose the adhesive layer adjacent the lateral edge on one surface of the substrate; the exposed adhesive is then adhered to the window flange. Subsequently, the remaining release liner is removed, exposing the underlying adhesive layer adjacent the lateral edge on the opposite surface of the substrate. Finally, WRB is installed over the wall surrounding the window and adhered to the exposed adhesive layer of the flashing along the sides and uppermost portion of the window. The WRB is advantageously covered by the substrate of the flashing at the lowermost portion of fenestration unit in a shingling fashion as described above.

Alternatively, the flashing of the invention can be installed by removing a portion of the release liner and adhering the flashing to the flange of the fenestration unit prior to installing the fenestration unit in the rough opening in the building wall. Thereafter, the remaining release liner can be removed and WRB is adhered to the exposed adhesive layer as described above.

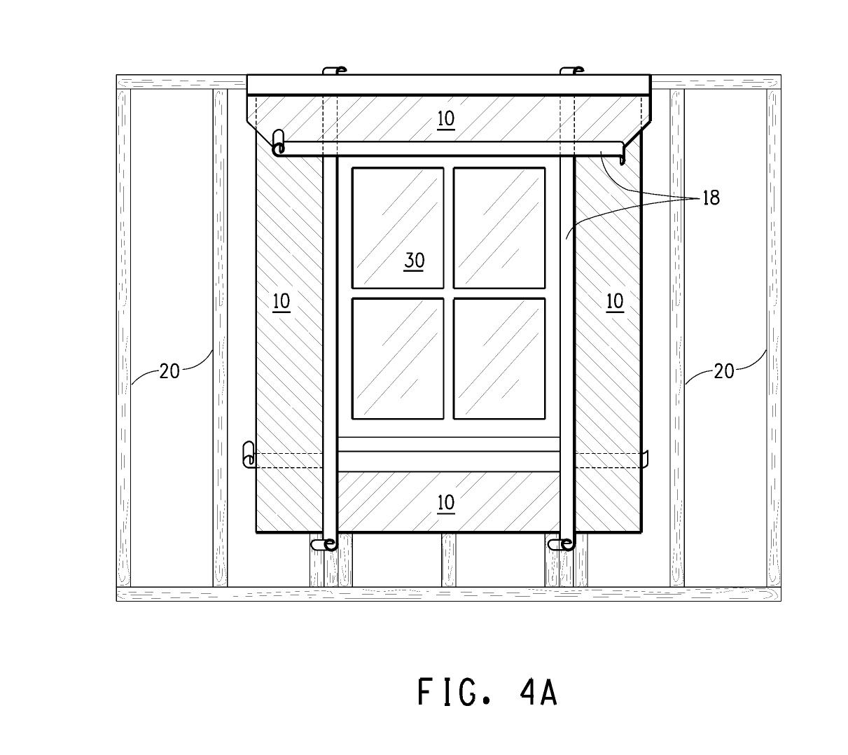

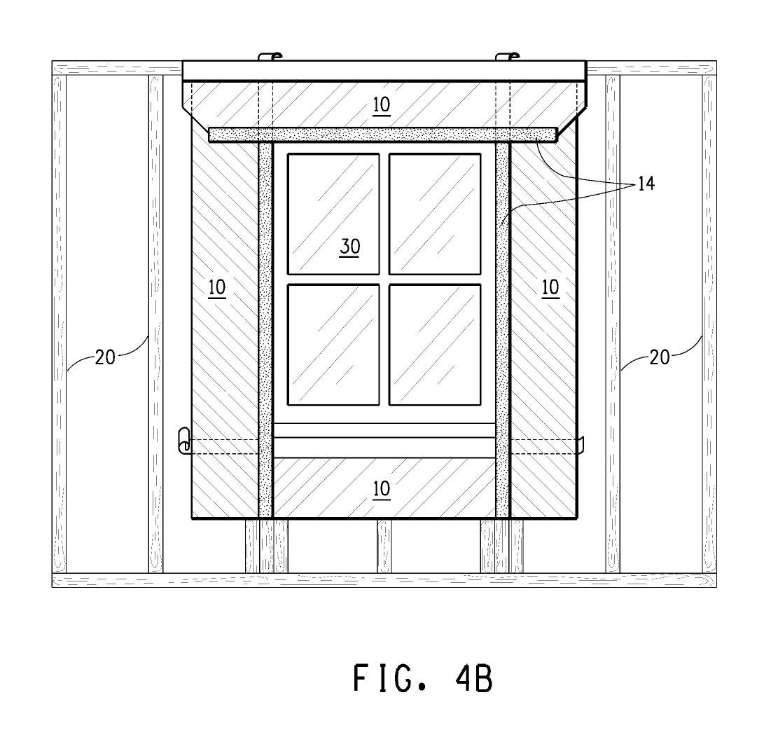

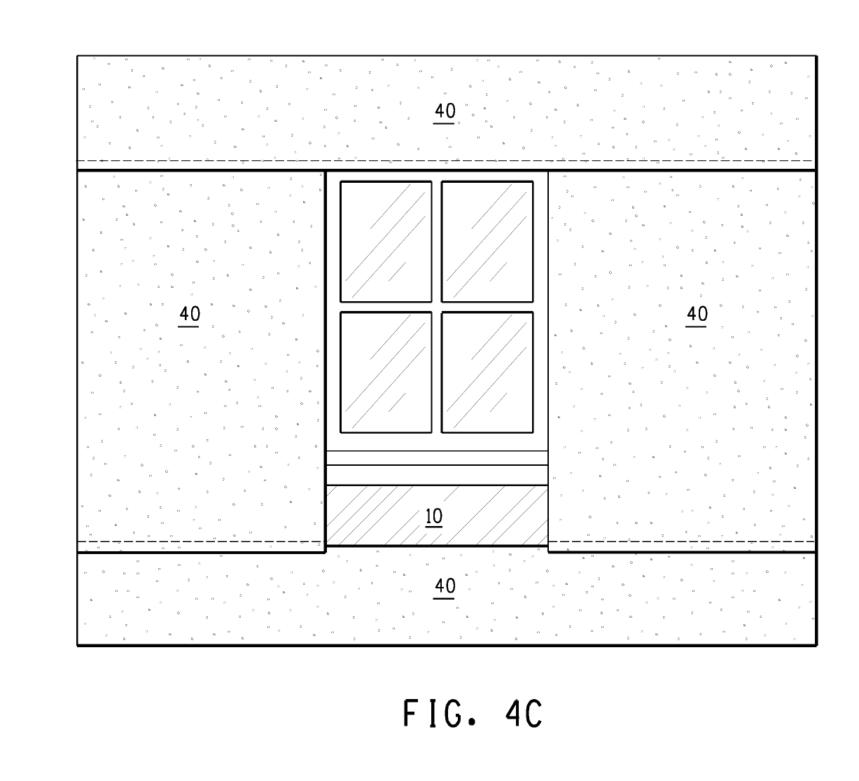

FIG. 4A illustrates an open-stud construction wall comprising framing members 20, installed window 30 and flashing 10 (or flashing 110) according to the invention installed around the window, before the installation of WRB and before the release liner 18a on the flashing is removed. FIG. 4B illustrates the same wall after release liner 18a on the flashing is removed to expose adhesive layer 14a. FIG. 4C illustrates the same wall after the installation of WRB 40.

Another embodiment of the invention is shown in FIG. 5 which depicts the cross-section of flashing 130. The flashing includes a first elongated adhesive layer 315 adhered to one of the major surfaces of the substrate, the first adhesive layer being substantially adjacent the first lateral edge 316 of the substrate 312. The first adhesive layer 315 is covered by release liner 317. The flashing 130 also includes a second elongated adhesive layer 314, covered by a release liner 318, adhered to the other major surface of the substrate such that the second elongated adhesive layer does not overlap the first elongated adhesive layer in the plane of the substrate 312. There is preferably a gap between the portion of the substrate covered by the first adhesive layer 315 and the portion of the substrate covered by the first adhesive layer 314. The width of each of the first and second adhesive layers is between about 1 inch (25.4 cm) and about 3 inches (76.2 cm). Preferably, the thickness of the first adhesive layer 315 is less than the thickness of the second adhesive layer 314.

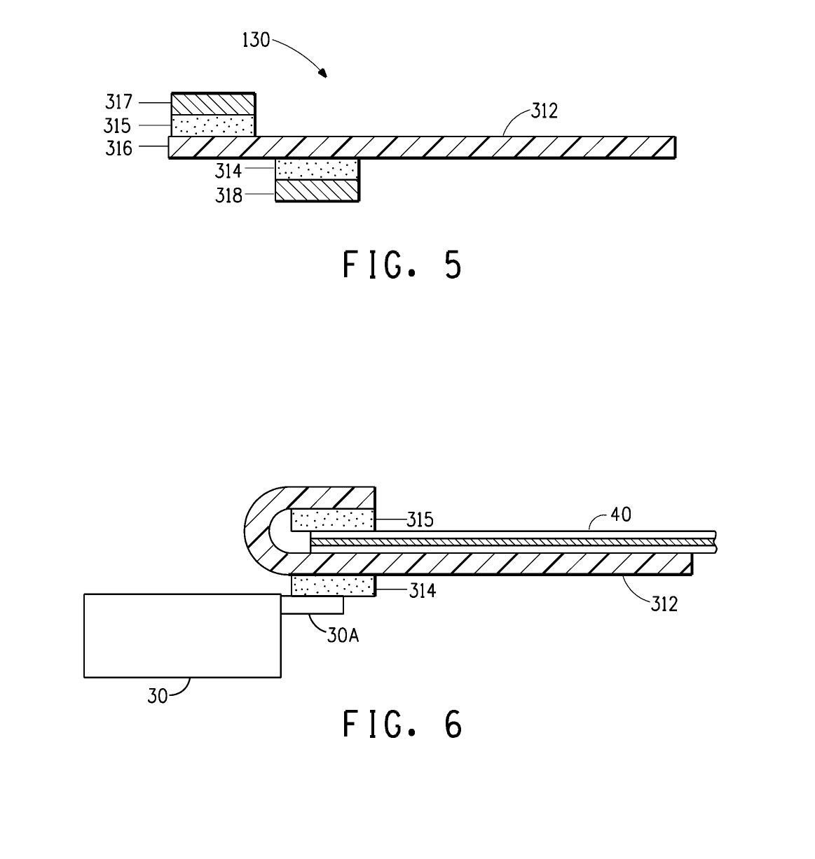

FIG. 6 shows the cross-section of flashing 130 in use as installed on the peripheral flange 30A of a window 30, and integrated with WRB 40. After removal of release liner 318, the second adhesive layer 314 is first adhered to the window flange. The WRB 40 is positioned over the substrate 312 opposite the adhesive layer 314 as shown. Release liner 317 is then removed, substrate 312 is folded over the WRB and the first adhesive layer 315 is adhered to the outer surface of WRB 40. The flashing 130 secures the WRB in place, which can be further secured by the use of tape or fasteners.

What is claimed is:

1. A flashing for integrating a flanged fenestration unit and a water resistive barrier, the flashing comprising:
(a) an elongated flexible substrate having two major surfaces and a first lateral edge and second lateral edge defining a width of the substrate therebetween, the substrate selected from the group consisting of nonwoven fabric, woven fabric, film, paper, sheet metal, and a combination thereof;
(b) an elongated adhesive layer having a width less than the width of the substrate adhered to each of the major surfaces of the substrate adjacent the first lateral edge of the substrate;
(c) a release liner covering each of the adhesive layers.

2. A flashing for integrating a flanged fenestration unit and a water resistive barrier, the flashing comprising:
(a) an elongated flexible substrate having two major surfaces and first and second lateral edges defining a width of the substrate therebetween, the substrate selected from the group consisting of nonwoven fabric, woven fabric, film, paper, sheet metal, and a combination thereof;
(b) a first elongated adhesive layer adhered to one of the major surfaces of the substrate wherein the first elongated adhesive layer has a first edge substantially adjacent the first lateral edge of the substrate and a second edge,
(c) a second elongated adhesive layer adhered to the other major surface of the substrate wherein the second elongated adhesive layer does not overlap the first elongated adhesive layer in the plane of the substrate;
(d) a release liner covering each of the adhesive layers.

3. A flashing for integrating a flanged fenestration unit and a water resistive barrier, the flashing comprising:
(a) an elongated flexible substrate having two major surfaces and a first lateral edge and second lateral edge defining a width of the substrate therebetween, the substrate selected from the group consisting of nonwoven fabric, woven fabric, film, paper, sheet metal, and combinations thereof;
(b) an elongated adhesive layer having a width less than the width of the substrate adhered to one of the major surfaces of the substrate such that elongated adhesive layer extends beyond the first lateral edge of the substrate;
(c) a first release liner covering only the width of the surface of the elongated adhesive layer that extends beyond the first lateral edge of the substrate
(d) a second release liner covering the entire width of the surface of the elongated adhesive layer opposite the surface in (c) wherein the second release liner is scored or perforated along a line parallel to the first lateral edge of the substrate and divides the second release liner into a first section and a second section.

4. The flashing of claim 2, wherein the first elongated adhesive layer and the second elongated adhesive layer each has a width of about 1 inch (2.54 cm) to 3 inches (7.6.2 cm).

5. A method for preventing the ingress of moisture into a wall of a building surrounding a flanged fenestration unit installed in a rough opening of the wall, the wall and the rough opening being defined by framing members, the method comprising:
(a) installing the fenestration unit in the rough opening such that the flange of the fenestration unit overlaps the framing members of the rough opening;
(b) providing a flashing comprising an elongated flexible substrate having two major surfaces and a first lateral edge and second lateral edge defining a width of the substrate therebetween, an elongated adhesive layer having a width less than the width of the substrate adhered to one of the major surfaces of the substrate adjacent the first lateral edge of the substrate, and a release liner covering the adhesive layer wherein the release liner is scored along a line parallel to the first lateral edge of the substrate and located a distance from the first lateral edge that is less than the width of the adhesive layer dividing the release liner into a first release liner section adjacent the first lateral edge and a second release liner section;
(c) folding the flashing along the scored line such that the substrate is folded on itself;
(d) removing the second release liner section from the flashing to expose a portion of the adhesive layer;
(e) adhering the exposed adhesive to the flange of the fenestration unit along the sides and uppermost portion of the fenestration unit;
(f) removing the first release liner section from the flashing to expose the remaining portion of the adhesive layer;
(g) installing water resistive barrier over the wall surrounding the fenestration unit such that the water resistive barrier is adhered to the remaining portion of the adhesive layer along the sides and uppermost portion of the fenestration unit and such that the water resistive barrier immediately below the lowermost portion of the fenestration unit is covered by the substrate of the flashing.

6. A method for preventing the ingress of moisture into a wall of a building surrounding a flanged fenestration unit installed in a rough opening of the wall, the wall and the rough opening being defined by framing members, the method comprising:
(a) installing the fenestration unit in the rough opening such that the flange of the fenestration unit overlaps the framing members of the rough opening;
(b) providing a flashing comprising an elongated flexible substrate having two major surfaces and a first lateral edge and second lateral edge defining a width of the substrate therebetween, an elongated adhesive layer having a width less than the width of the substrate adhered to each of the major surfaces of the substrate adjacent the first lateral edge of the substrate, and a release liner covering each of the adhesive layers;
(c) removing the release liner from one of the adhesive layers to expose the adhesive layer;
(d) adhering the exposed adhesive layer to the flange of the fenestration unit along the sides and uppermost portion of the fenestration unit;
(e) removing the release liner from the flashing to expose the remaining adhesive layer;
(f) installing water resistive barrier over the wall surrounding the fenestration unit such that the water resistive barrier is adhered to the remaining adhesive layer along the sides and uppermost portion of the fenestration unit and such that the water resistive barrier immediately below the lowermost portion of the fenestration unit is covered by the substrate of the flashing.

7. A method for preventing the ingress of moisture into a wall of a building surrounding a flanged fenestration unit installed in a rough opening of the wall, the wall and the rough opening being defined by framing members, the method comprising:
(a) providing a flashing comprising an elongated flexible substrate having two major surfaces and a first lateral edge and second lateral edge defining a width of the substrate therebetween, an elongated adhesive layer having a width less than the width of the substrate adhered to one of the major surfaces of the substrate adjacent the first lateral edge of the substrate, and a release liner covering the adhesive layer wherein the release liner is scored along a line parallel to the first lateral edge of the substrate and located a distance from the first lateral edge that is less than the width of the adhesive layer dividing the release liner into a first release liner section adjacent the first lateral edge and a second release liner section;
(b) folding the flashing along the scored line such that the substrate is folded on itself;
(c) removing the second release liner section from the flashing to expose a portion of the adhesive layer;
(d) adhering the exposed adhesive to the flange of a fenestration unit along the sides and uppermost portion of the fenestration unit;
(e) installing the fenestration unit in the rough opening such that the flange of the fenestration unit overlaps the framing members of the rough opening;
(f) removing the first release liner section from the flashing to expose the remaining portion of the adhesive layer;
(g) installing water resistive barrier over the wall surrounding the fenestration unit such that the water resistive barrier is adhered to the remaining portion of the adhesive layer along the sides and uppermost portion of the fenestration unit and such that the water resistive barrier immediately below the lowermost portion of the fenestration unit is covered by the substrate of the flashing.

8. A method for preventing the ingress of moisture into a wall of a building surrounding a flanged fenestration unit installed in a rough opening of the wall, the wall and the rough opening being defined by framing members, the method comprising:
(a) providing a flashing comprising an elongated flexible substrate having two major surfaces and a first lateral edge and second lateral edge defining a width of the substrate therebetween, an elongated adhesive layer having a width less than the width of the substrate adhered to each of the major surfaces of the substrate adjacent the first lateral edge of the substrate, and a release liner covering each of the adhesive layers;
(b) removing the release liner from one of the adhesive layers to expose the adhesive layer;
(c) adhering the exposed adhesive layer to the flange of a fenestration unit along the sides and uppermost portion of the fenestration unit;
(d) installing the fenestration unit in the rough opening such that the flange of the fenestration unit overlaps the framing members of the rough opening;
(e) removing the release liner from the flashing to expose the remaining adhesive layer;
(f) installing water resistive barrier over the wall surrounding the fenestration unit such that the water resistive barrier is adhered to the remaining adhesive layer along the sides and uppermost portion of the fenestration unit and such that the water resistive barrier immediately below the lowermost portion of the fenestration unit is covered by the substrate of the flashing.

9. A method for forming the flashing of claim 1, comprising:
(a) providing a flashing starting material comprising:
(i) an elongated flexible substrate having two major surfaces and a first lateral edge and second lateral edge defining a width of the substrate therebetween, the substrate selected from the group consisting of nonwoven fabric, woven fabric, film, paper, sheet metal, and a combination thereof;
(ii) an adhesive layer adhered to one of the major surfaces of the substrate such that a first portion of the adhesive layer covers a portion of the substrate adjacent the first lateral edge of the substrate in the second portion of the adhesive layer extends beyond the first lateral edge;
(iii) a release liner covering the adhesive layer on the side opposite the substrate wherein the release liner is scored along the lateral edge of the substrate;
(b) folding the adhesive layer over the lateral edge of the substrate so that the adhesive layer is adhered to each of the major surfaces of the substrate.

10. The method of claim 9, wherein the starting flashing material further comprises an intermediate release liner covering the second portion of the adhesive layer extending beyond the first lateral edge, the method further comprising removing the intermediate release liner prior to folding the adhesive layer over the lateral edge of the substrate.
